(19) United States
(12) Patent Application Publication
(10) Pub. No.: US 2015/0170196 A1
(43) Pub. Date: Jun. 18, 2015

(54) Trend Detection in Online Advertising

(71) Applicant: Kenshoo Ltd., Tel Aviv (IL)

(72) Inventor: Moti Meir, Modiin (IL)

(21) Appl. No.: 14/182,161

(22) Filed: Feb. 17, 2014

Related U.S. Application Data
(60) Provisional application No. 61/917,438, filed on Dec. 18, 2013.

(51) Int. Cl. G06Q 30/02

(52) U.S. Cl. CPC G06Q 30/0242

(57) ABSTRACT

A method for trend detection in online advertising, the method comprising using at least one hardware processor for: receiving current performance data associated with a current online ad entity; determining a class with which the current online ad entity is associated, by applying a clustering algorithm to one or more attributes associated with the current online ad entity; fetching historical performance data associated with one or more historical online ad entities associated with the class; and comparing a behavior of the current performance data with a behavior of the historical performance data, to detect an abnormal trend in the behavior of the current online ad entity.

### CROSS REFERENCE TO RELATED APPLICATIONS

This application claims benefit of U.S. Provisional Patent Application No. 61/917,438, filed Dec. 18, 2013, which is hereby incorporated by reference in its entirety.

### TECHNICAL FIELD

Embodiments of the disclosure relate to the field of online advertising.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries. Similarly, content targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for trend detection in online advertising, the method comprising using at least one hardware processor for: receiving current performance data associated with a current online ad entity; determining a class with which the current online ad entity is associated, by applying a clustering algorithm to one or more attributes associated with the current online ad entity; fetching historical performance data associated with one or more historical online ad entities associated with the class; and comparing a behavior of the current performance data with a behavior of the historical performance data, to detect an abnormal trend in the behavior of the current online ad entity.

There is further provided, in accordance with an embodiment, a method for trend detection in online advertising, the method comprising using at least one hardware processor for: receiving performance data associated with an online ad entity, the performance data comprising at least two performance metrics; detecting an interrelation between the at least two performance metrics over time; comparing the interrelation with a rule set characterizing behavioral trends associated with the two performance metrics; and based on the comparing, indicating that one of the behavioral trends has been identified.

There is further provided, in accordance with an embodiment, a computer program product for trend detection in online advertising, the computer program product comprising a non-transitory computer-readable storage medium having program code embodied therewith, the program code executable by at least one hardware processor to: receive current performance data associated with a current online ad entity; determine a class with which the current online ad entity is associated, by applying a clustering algorithm to one or more attributes associated with the current online ad entity; fetch historical performance data associated with one or more historical online ad entities associated with the class; and compare a behavior of the current performance data with a behavior of the historical performance data, to detect an abnormal trend in the behavior of the current online ad entity.

There is further provided, in accordance with an embodiment, a computer program product for trend detection in online advertising, the computer program product comprising a non-transitory computer-readable storage medium having program code embodied therewith, the program code executable by at least one hardware processor to: receive performance data associated with an online ad entity, the performance data comprising at least two performance metrics; detect an interrelation between the at least two performance metrics over time; compare the interrelation with a rule set characterizing behavioral trends associated with the two performance metrics; and based on the comparing, indicate that one of the behavioral trends has been identified.

In some embodiments, the current performance data comprises one or more time series of one or more performance parameters, respectively.

In some embodiments, the one or more time series comprise two or more time series, and wherein the one or more performance parameters comprise two or more performance parameters, respectively.

In some embodiments, the historical performance data comprises one or more time series of one or more performance parameters, respectively.

In some embodiments, the one or more time series comprise two or more time series, and wherein the one or more performance parameters comprise two or more performance parameters, respectively.

In some embodiments, the current online ad entity and the historical online ad entity are each selected from the group consisting of: an individual ad, a set of ads, a campaign and a set of campaigns.

In some embodiments, the one or more performance parameters are selected from the group consisting of: impressions, clicks, click-through rate (CTR), conversions, return on investment (ROI), revenue per click, cost per impression, cost per click, revenue per impression, reach and frequency.

In some embodiments, the current performance data is of a time window equal in length to a time window of the historical performance data.

In some embodiments, each of the at least two performance metrics comprises a time series.

In some embodiments, the at least two performance metrics comprise at least three performance metrics.

In some embodiments, the online ad entity is selected from the group consisting of: an individual ad, a set of ads, a campaign and a set of campaigns.

In some embodiments, the at least two performance metrics are selected from the group consisting of: impressions, clicks, click-through rate (CTR), conversions, return on investment (ROI), revenue per click, cost per impression, cost per click, revenue per impression, reach and frequency.

In some embodiments, the method further comprises using the at least one hardware processor for transmitting a command to an advertising platform, to affect a monetary parameter pertaining to the current online ad entity, wherein the command is based on the detected abnormal trend or on the identified one of the behavioral trends.

In some embodiments, the program code is further executable by the at least one hardware processor for transmitting a command to an advertising platform, to affect a monetary parameter pertaining to the online ad entity, wherein the command is based on the detected abnormal trend or on the identified one of the behavioral trends.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a schematic of an exemplary a cloud computing node;

FIG. 2 shows an illustrative cloud computing environment;

FIG. 3 shows a set of functional abstraction layers provided by the cloud computing environment;

FIG. 4 shows a flow chart of a method for trend detection in online advertising; and

FIG. 5 shows a flow chart of another method for trend detection in online advertising.

### DETAILED DESCRIPTION OF ILLUSTRATIVE EMBODIMENTS

Methods for trend detection in online advertising are disclosed herein. Advantageously, the methods may be capable of detecting a trend in or based on the performance of an online ad entity, even if no substantial historical data is available for that online ad entity. Exemplary scenarios may include a relatively new ad entity for which there exists only a short history (typically a few hours up to a few days), or an ad entity which was active in the past, paused for a certain duration and then reactivated; in the latter case, the history available from the past activation of the ad entity may be too old to rely upon when trying to detect a trend in the current activation of the ad entity. A further scenario is an ad entity for which only a sparse history exists; it could even be an ad that has been active for a substantial duration, but due to various factors did not yield many impressions, clicks, conversions and/or the like—thereby making it difficult to reliably analyze its performance.

### GLOSSARY

“Online advertising platform” (or simply “advertising platform”): This term, as referred to herein, may relate to a service offered by an advertising business to different advertisers. In the course of this service, the advertising business displays ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed in various web sites which are affiliated with the advertising business (these web sites constituting what is often referred to as a “display network”) and/or in one or more web sites operated directly by the advertising business.

AdWords, a service operated by Google, Inc. of Mountain View, Calif., is a prominent example of an advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users—parameters which are readily available in many social networks and are usually provided by the users themselves. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad may include and/or be associated with a set of parameters, such as searched keywords to target, geographies to target, demographics to target, a bid for utilization of advertising resources of the advertising platform, and/or the like.

To aid advertisers in neatly organizing their ads, advertising platforms often allow grouping individual ads in sets, such as the “AdGroups” feature in Google AdWords. The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads.

“Performance”: This term, as referred to herein with regard to an ad, may relate to various statistics gathered in the course of running the ad. A “running” phase of the ad may refer to a duration in which the ad was served (and hence displayed) to users, or at least to a duration during which the advertiser defined that the ad should be served. The term “performance” may also relate to an aggregate of various statistics gathered for a set of ads, a campaign, etc. The statistics may include multiple parameters (also “metrics”). Exemplary metrics are:
“Impressions”: the number of times the ad has been served to users;
“Reach”: the number of unique users who have been exposed to the ad. This differs from “impressions” in that the reach metric does not increase when the same user is exposed to the same ad multiple times, whereas the impressions metric does. The reach metric is very common in social advertising platforms;
“Frequency”: the number of times a certain user has been exposed to the same ad. This metric is very common in social advertising platforms;
“Clicks”: the number of times users clicked (or otherwise interacted with) the ad entity;
“Cost per click (CPC)”: the average cost of a click (or another interaction with an ad entity) to the advertiser;
“Cost per impression”: the average cost of an impression to the advertiser;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser. For examples, users who purchased an advertised product, users who subscribed to an advertised service, or users who filled in their details in a lead generation form;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity). This may be calculated as a function of the clicks, conversions and the advertiser's average revenue per conversion;
“Revenue per impression”: the average amount of revenue generated to the advertiser per impression of the ad entity. This may be calculated as a function of the impressions, conversions, and the advertiser's average revenue per conversion;

In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

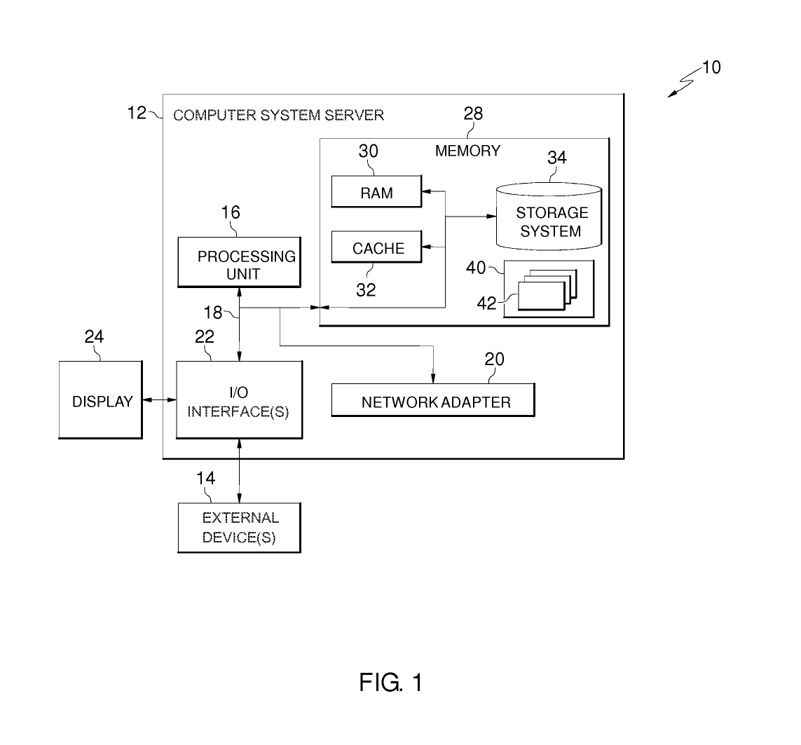

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

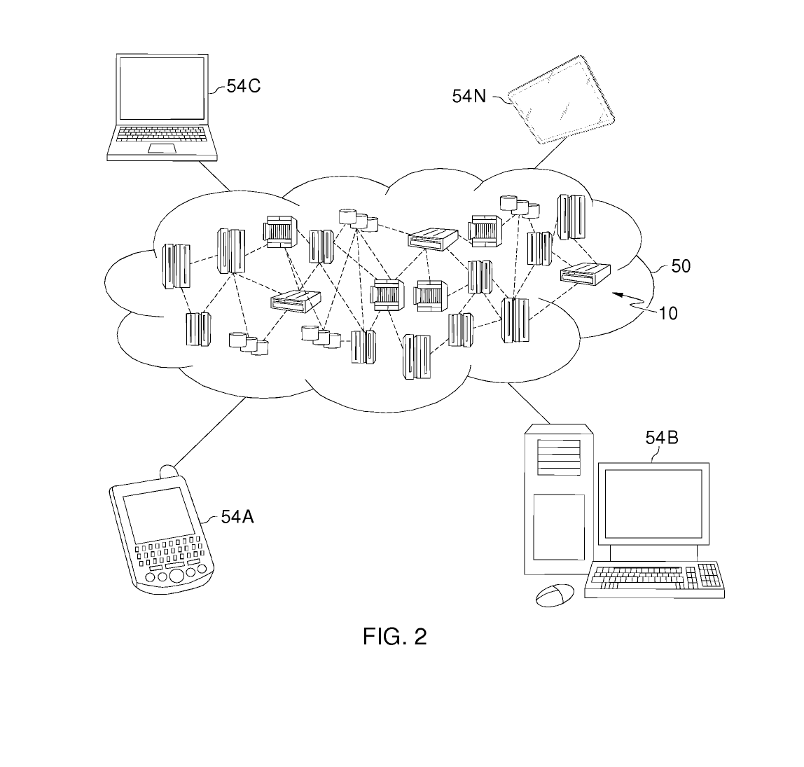

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or tablet computing device 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

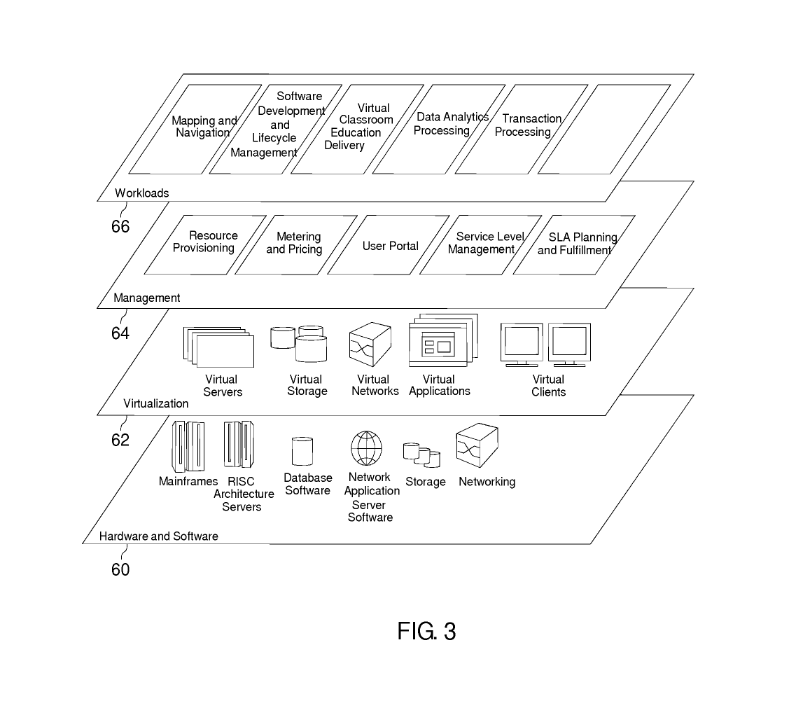

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

As briefly discussed above, disclosed herein are methods for trend detection in online advertising. These methods may be capable of detecting a trend in or based on the performance of an online ad entity, even if no substantial historical data is available for that online ad entity.

In a first embodiment, the detection of a trend, notwithstanding the lack of substantial historical data, is enabled by determining a class with which the ad entity is associated, and fetching historical performance data of one or more other historical ad entities associated with that same class. This course of action is based upon the assumption, empirically validated by the present inventors, that ad entities of the same class tend to behave similarly. Accordingly, it may be possible to detect whether the ad entity, which should theoretically behave similar to other ad entities in its class, exhibits an abnormal trend in relation to its class.

In a second embodiment, the detection of a trend, notwithstanding the lack of substantial historical data, is enabled by advantageous analysis of the existing (typically short-range) performance data of the ad entity. In this analysis, an interrelation between at least two performance metrics of the ad entity is detected. Then, the interrelation is compared with a pre-provided rule set which characterizes different behavioral trends and their expression in different interrelations between multiple performance metrics. If the detected interrelation between the at least two performance metrics of the ad entity matches any of the interrelations in the rule set, it may be deemed that a respective behavioral trend (or plural trends) in the rule set has manifested for the ad entity.

In any of these or other embodiments, the detected trend is optionally formulated and expressed as a positive, negative or neutral value. A positive value may indicate a trend which is considered to be good to an advertiser, namely—the ad performs well and yields utility to the advertiser. A negative value may indicate a trend which is considered to be bad to an advertiser, namely—the ad performs poorly and lacks utility to the advertiser. A neutral value, in turn, may indicate an interim status, in which the advertiser is indifferent to the performance of the ad. Optionally, the detected trend is denoted as a value between 1 and −1, with 1 being the strongest positive value, 0 being neutral and −1 being the strongest negative value.

Optionally, at least some actions of each of the first and second embodiments may be combined, to form a third embodiment. For example, a positive trend may automatically trigger a positive adjustment of the budget and/or bid policy associated with the ad and according to the pre-defined rule, while a negative trend may trigger the opposite. In another example, a negative trend, under/above a pre-defined threshold, may cease advertising the ad or the campaign all together.

In some embodiments, the methods are executed with respect to an ad entity which is or has been running in an advertising platform operative in accordance with a decaying policy. The decaying policy in such advertising platforms prescribes that ads receive an amount of initial exposure to users, and the exposure decays over time. The decaying, in some existing advertising platforms, is a process lasting anywhere between a few hours up to a few days or even weeks, and sometime decay with a rate related to the relevancy of the ad or the goods the ad is offering. The decaying policy is oftentimes found in social advertising platforms. The rationale behind it may be that the same ads in social advertising platforms are usually served to the same users (being the defined target audience) multiple times. After a while, naturally, the relevancy of the ads to the users in the target audience diminishes; experience teaches that if the users wished to click on (or otherwise interact with) the ad, they are more likely to do so in one of the first times the ads are being served to them. In search, where the user has intent to purchase an item, the relevancy decays with respect to the availability/relevancy of the goods being advertised, e.g. a rock concert at a specific date.

In some other embodiments, the methods are executed with respect to an ad entity which is or has been running in an advertising platform operative in accordance with a non-decaying policy—in which each ad may be entitled to receive more or less the same exposure over time.

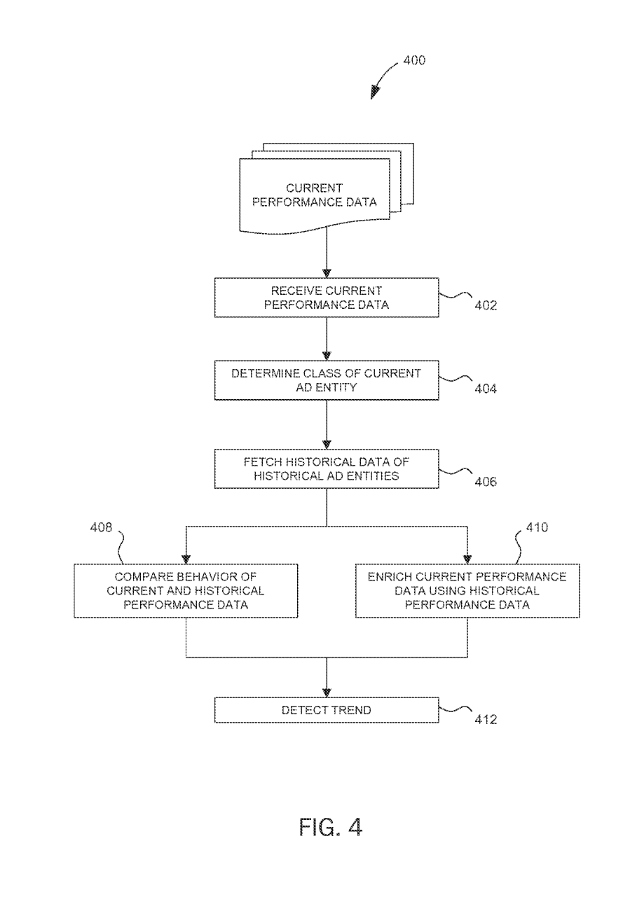

Reference is now made to FIG. 4, which shows a flow chart of a method 400 for trend detection in online advertising, in accordance with the first embodiment.

In a step 402, current performance data associated with a current online ad entity (or simply “ad entity”) is received. The word “current” as it refers to an ad entity, may relate to an ad entity for which a user now desires to detect a trend. This ad entity is either running, presently, in an advertising platform, or has been running there until recently. “Recently”, in some embodiments, may relate to a few hours up to a few days, optionally 7 days, prior to the trend detection using method 400.

The term “current performance data”, in turn, may refer to performance data which is associated with the current ad entity. Namely, the current performance data contains one or more performance metrics gathered for the current ad entity while it was running.

The performance data may be structured as one or more time series, each pertaining to a different performance metric. For example, a time series of an impression metric may include an indication of the number of impressions over time. In some embodiments, these one or more time series may include two or more time series; in some further embodiments, these two or more time series may include three or more time series.

In a step 404, a class with which the current ad entity is associated is determined. This may be performed by applying a clustering (also “classification”) algorithm to one or more attributes associated with the current ad entity. An example of such algorithm is the classification method disclosed in applicant's co-pending U.S. patent application Ser. No. 13/369,621, filed Feb. 9, 2012 and entitled “A System, a Method and a Computer Program Product for Performance Assessment”. Additionally or alternatively, the determination of the class may be performed according to different one or more classification methods known in the art. Generally speaking, in machine learning and statistics, classification is the problem of identifying to which of a set of classes a new observation belongs, on the basis of a training set of data containing observations whose class membership is known.

To facilitate the classification, a database containing historical ad entities which have been previously classified, may be provided. The database may include one or more attributes associated with each such historical ad entity. The classification of the current ad entity may then be conducted by comparison to the database. Typically, each type of entity has relevant attributes. To this end, the following attributes may be provided for the current ad entity (typically, each type of entity has relevant attributes): If the current ad entity is an individual ad, attributes may include the number of words in the ad, the targeting of the ad (e.g. age, sex), the existence of a picture in the ad, features of the picture itself (e.g. size, colors, etc), the structure of the ad, the type of ad, the landing page which the ad refers to (a link). For a group of ads or a campaign, attributes may include the top performance keywords which trigger the ad, the number of associated keywords, historical performance data of the group (i.e. total no. of click, average quality score), etc.

Alternatively, step 404 may be done based on manual categorization of classes, for example, classing per product type of business unit of an advertiser.

In a step 406, historical performance data associated with one or more of the historical ad entities is fetched. The historical performance data may be fetched, for example, from an online advertising platform and/or from a database not belonging to the advertising platform but used for storing data collected from the advertising platform. As one example, this database may be the same one as the database including the historical ad entities.

Specifically, as to the fetching, the historical performance data may be fetched only for those of the historical ad entities which are associated with the same class as the current ad entity. Advantageously, this historical performance data may serve as a substitute for historical performance data of the current ad entity itself.

The historical performance data, similar to the current performance data, may be structured as one or more time series—one for each performance metric. In some embodiments, these one or more time series may include two or more time series; in some further embodiments, these two or more time series may include three or more time series.

The historical performance data and the current performance data optionally pertain to time windows equal in length. For example, they may both include performance data collected over the same number of days or over the same dates but in different years.

At this point, method 400 may split into two alternative paths:

In a first path, which is shown in a step 408, a behavior of the current performance data may be compared with a behavior of the historical performance data. In this comparison, one or more performance metrics of the current performance data may be compared with corresponding one or more performance metrics of the historical performance data. Namely, each performance metric is compared across current and historical performance data. This comparison may detect 412 an abnormal trend (or a lack thereof) in the behavior of the current ad entity. Such an abnormal trend is sometimes hidden in the current performance data. Namely, its abnormality is only when it is compared with a behavior of historical ads of the same class. For example, even if the CTR metric of the current performance data shows an increase, it does not necessarily mean that the trend is positive. If the CTR metric of the historical performance data shows a much higher increase (per time unit) than the one in the current performance data, it may signal that the trend in the current performance data is actually a negative or a neutral one.

In a second path, shown in a step 410, the historical performance data may be used to enrich the current performance data. In other words, for each metric of interest in the current performance data, the time series of this metric may be thickened with points taken from the historical performance data. At least some of the added points may be intertwined with points existing in the current performance data, to yield an interpolation of the current performance data. Additionally or alternatively, at least some of the added points may be added to area(s) in the time series of the current performance data which completely lack data, thereby yielding an extrapolation of the current performance data. In either case, a non-linear curve fitting algorithm may be applied to the aggregate of points from the current and historical performance data, in order to construct an estimated function graph for each desired metric. The curve fitting algorithm may produce, for example, a function graph which is either polynomial, logarithmic, exponential, trigonometric or hyperbolic. The Y axis of this graph may be a value of the pertinent metric, whereas the X axis may be time. A trend may then be detected 412 in this functional form, for example by comparing its values (Y) in different time points (X). Additionally or alternatively, a trend may be detected by deriving the function. Further additionally or alternatively, a trend may be detected by employing one or more kernel methods for pattern analysis, as known in the art. The kernel methods may find various relations (e.g. clusters, rankings, correlations, classifications, etc.) in the functional form.

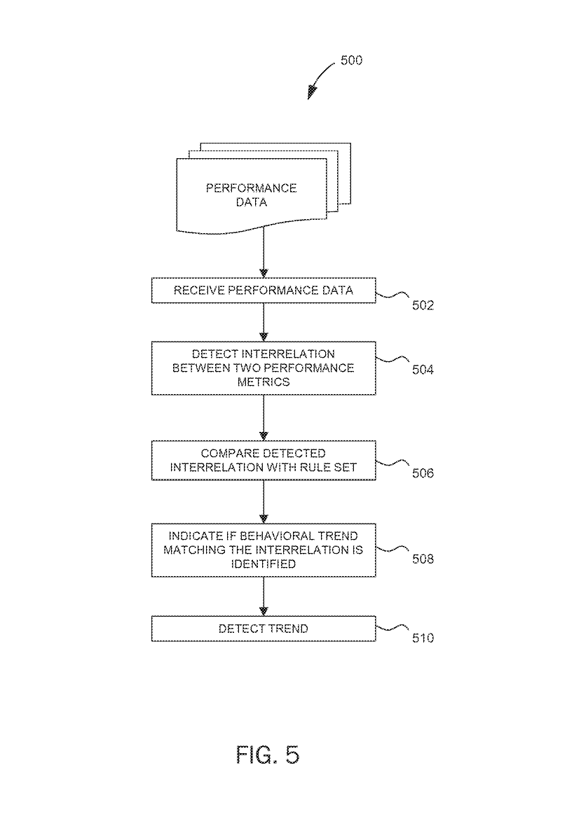

Reference is now made to FIG. 5, which shows a flow chart of a method 500 for trend detection in online advertising, in accordance with the second embodiment.

In a step 502, performance data associated with an online ad entity (or simply “ad entity”) is received. This ad entity is either running, presently, in an advertising platform, or has been running there until recently. “Recently”, in some embodiments, may relate to a few hours up to a few days, optionally 7 days, prior to the trend detection using method 500.

The term “performance data”, in turn, may refer to performance data which is associated with the current ad entity. The performance data may contain at least two performance metrics gathered for the ad entity while it was running. In some embodiments, the performance data may contain at least three performance metrics.

The performance data may be structured as one or more time series, each pertaining to a different performance metric. For example, a time series of an impression metric may include an indication of the number of impressions over time. In some embodiments, these one or more time series may include two or more time series; in some further embodiments, these two or more time series may include three or more time series.

In a step 504, an interrelation between the at least two performance metrics over time may be detected. The interrelation, for example, may be expressed in a similar behavior (e.g. upwards trend, downwards trend) of the at least two performance metrics over time. As another example, the interrelation may be expressed in an approximately inversely-correlated behavior of the at least two performance metrics over time.

The interrelation may be detected, for example, my combining the one or more time series of the performance data into an N-dimensional plane (N being the number of participating metrics) and detecting one or more hyperplanes in this N-dimensional plane; these hyperplanes may be indicative of the sought after interrelation.

In a step 506, the detected interrelation may be compared with a rule set which characterizes behavioral trends associated with the two (or more) performance metrics. The rule set may be predefined and stored, for example, in a database. Each rule in the rule set may include a pair (or a larger group) of performance metrics which behave in a certain way in relation to each other, wherein this behavior constitutes a certain trend. For example, two performance metrics having opposite or similar slopes at a point of intersection, two performance metrics having opposite or similar slopes at a certain X value, etc.

Each rule may additionally include an indication of whether such a trend constitutes a positive, neutral or negative trend. For example, a behavioral trend of a declining CTR but increasing conversions may be classified as positive, whereas a behavioral trend of declining impressions and declining conversions may be classified as negative. Optionally, a magnitude of these trends may also be indicated in the database, and be correlated with the intensity of the behavioral trend of the two or more performance metrics. Optionally, a trend may be classified as positive, neutral or negative based on its effect on revenue associated with one or more of the performance metrics.

In a step 508, based on the (one or more) comparisons of step 506, it may be indicated whether one of the behavioral trends appearing in the rule set has been identified as matching the interrelation detected in step 504. Namely, the matching behavioral trend can be reliably deemed to represent the trend of the performance data of the pertinent ad entity. Thereby, a trend has been detected 510.

Following the detection of a trend in accordance with any of the embodiments above (namely, the first or second embodiment), one or more commands may be transmitted to the advertising platform in which the pertinent ad entity is or has been running or displayed. The commands may be issued by a bidding system, being a software program product in nature. These commands may be based on the detected trend, and affect accordingly one or more monetary parameters pertaining to the ad entity, such as bids for keywords, placements, geographic locations and/or any other parameter associated with the ad entity. Additionally or alternatively, the command(s) may affect an overall budget assigned to the ad entity. As a further example, the command(s) may pause an ad entity from running or displayed.

In a typical example, a lowering of a bid and/or a budget may be applied if a detected trend is negative, and an increase of a bid and/or a budget may be applied if a detected trend is positive.

The following are examples for commands affecting the bid and/or budget of an ad entity:

### Example 1

A negative trend has been detected: An ROI decrease for an ad, accompanied by the fact that the cost for this ad has increased significantly with no correlated lift in revenue, such that this ad is no longer profitable and actually causes the advertiser to lose money. The bidding system picks this signal and bids down that ad such that the impressions correlate with the expected revenue from the ad. Accordingly, the ROI may be as desired by the advertiser. If that ROI cannot be achieved, the bidding system decide to pause that ad and stop the loss.

### Example 2

A negative trend has been detected: An ROI decrease for an ad, accompanied by a revenue for this which has decreased much faster compared to the cost. The bidding system pick this signal and bids down this ad, to allocate the saved funds to another ad that was detected as having an ROI lift trend. In such a way, the bidding system maximizes the market opportunity and the return on investment for the advertiser.

### Example 3

A negative trend has been detected: a decrease in impressions for a specific ad. The bidding system is also notified that the ROI for that ad was good up until the impressions drop. The budgeting system sees that the specific ad is part of a campaign which almost depleted its budget, and hence decides to allocate more budget for that campaign containing the ad (for example taking it from campaigns that have ads which perform worse than the specific ad).

### Example 4

A positive trend has been detected: an ad perform well in terms of ROI. However, the cost for the ad had increased significantly, and the CPC for that ad has increased in correlation (probably due to competition). The budgeting system also sees that the budget pacing has increased such that the ad's campaign budget will be depleted before the end of the day. The budgeting system decides to reallocate funds from other (slow pacing or less performing) campaigns to the campaign containing this specific ad. By that, the budgeting system makes sure that funds are well allocated in real time to the best performing ads, and reacts to market trend signals such that it maximizes the advertiser's market opportunity and return on investment.

### Example 5

A positive trend has been detected: an ad performs well in terms of ROI. However the cost for the ad had increased significantly in correlation to higher CPC for that ad. The system may report a “competition” situation over a “hot” ad to the advertiser, in real time. No action in the advertising platform is necessarily taken.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated.

What is claimed:

1. A method for trend detection in online advertising, the method comprising using at least one hardware processor for:
receiving current performance data associated with a current online ad entity;
determining a class with which the current online ad entity is associated, by applying a clustering algorithm to one or more attributes associated with the current online ad entity;
fetching historical performance data associated with one or more historical online ad entities associated with the class; and
comparing a behavior of the current performance data with a behavior of the historical performance data, to detect an abnormal trend in the behavior of the current online ad entity.

2. The method according to claim 1, wherein the current performance data comprises one or more time series of one or more performance parameters, respectively.

3. The method according to claim 2, wherein the one or more time series comprise two or more time series, and wherein the one or more performance parameters comprise two or more performance parameters, respectively.

4. The method according to claim 1, wherein the historical performance data comprises one or more time series of one or more performance parameters, respectively.

5. The method according to claim 4, wherein the one or more time series comprise two or more time series, and wherein the one or more performance parameters comprise two or more performance parameters, respectively.

6. The method according to claim 1, wherein the current online ad entity and the historical online ad entity are each selected from the group consisting of: an individual ad, a set of ads, a campaign and a set of campaigns.

7. The method according to claim 1, wherein the one or more performance parameters are selected from the group consisting of: impressions, clicks, click-through rate (CTR), conversions, return on investment (ROI), revenue per click, cost per impression, cost per click, revenue per impression, reach and frequency.

8. The method according to claim 1, wherein the current performance data is of a time window equal in length to a time window of the historical performance data.

9. The method according to claim 1, further comprising using the at least one hardware processor for transmitting a command to an advertising platform, to affect a monetary parameter pertaining to the current online ad entity,
wherein the command is based on the detected abnormal trend.

10. A method for trend detection in online advertising, the method comprising using at least one hardware processor for:
receiving performance data associated with an online ad entity, the performance data comprising at least two performance metrics;
detecting an interrelation between the at least two performance metrics over time;
comparing the interrelation with a rule set characterizing behavioral trends associated with the two performance metrics; and
based on the comparing, indicating that one of the behavioral trends has been identified.

11. The method according to claim 10, wherein each of the at least two performance metrics comprises a time series.

12. The method according to claim 10, wherein the at least two performance metrics comprise at least three performance metrics.

13. The method according to claim 10, wherein the online ad entity is selected from the group consisting of: an individual ad, a set of ads, a campaign and a set of campaigns.

14. The method according to claim 10, wherein the at least two performance metrics are selected from the group consisting of: impressions, clicks, click-through rate (CTR), conversions, return on investment (ROI), revenue per click, cost per impression, cost per click, revenue per impression, reach and frequency.

15. The method according to claim 10, further comprising using the at least one hardware processor for transmitting a command to an advertising platform, to affect a monetary parameter pertaining to the online ad entity,
wherein the command is based on the identified one of the behavioral trends.

16. A computer program product for trend detection in online advertising, the computer program product comprising a non-transitory computer-readable storage medium having program code embodied therewith, the program code executable by at least one hardware processor to:
receive current performance data associated with a current online ad entity;
determine a class with which the current online ad entity is associated, by applying a clustering algorithm to one or more attributes associated with the current online ad entity;
fetch historical performance data associated with one or more historical online ad entities associated with the class; and
compare a behavior of the current performance data with a behavior of the historical performance data, to detect an abnormal trend in the behavior of the current online ad entity.

17. The computer program product according to claim 16, wherein the current performance data comprises one or more time series of one or more performance parameters, respectively.

18. The computer program product according to claim 17, wherein the one or more time series comprise two or more time series, and wherein the one or more performance parameters comprise two or more performance parameters, respectively.

19. The computer program product according to claim 16, wherein the historical performance data comprises one or more time series of one or more performance parameters, respectively.

20. The computer program product according to claim 19, wherein the one or more time series comprise two or more time series, and wherein the one or more performance parameters comprise two or more performance parameters, respectively.

21. The computer program product according to claim 16, wherein the current online ad entity and the historical online ad entity are each selected from the group consisting of: an individual ad, a set of ads, a campaign and a set of campaigns.

22. The computer program product according to claim 16, wherein the one or more performance parameters are selected from the group consisting of: impressions, clicks, click-through rate (CTR), conversions, return on investment (ROI), revenue per click, cost per impression, cost per click, revenue per impression, reach and frequency.

23. The computer program product according to claim 16, wherein the current performance data is of a time window equal in length to a time window of the historical performance data.

24. The computer program product according to claim 16, wherein the program code is further executable by the at least one hardware processor for transmitting a command to an advertising platform, to affect a monetary parameter pertaining to the online ad entity,
wherein the command is based on the detected abnormal trend.

25. A computer program product for trend detection in online advertising, the computer program product comprising a non-transitory computer-readable storage medium having program code embodied therewith, the program code executable by at least one hardware processor to:
receive performance data associated with an online ad entity, the performance data comprising at least two performance metrics;
detect an interrelation between the at least two performance metrics over time;
compare the interrelation with a rule set characterizing behavioral trends associated with the two performance metrics; and
based on the comparing, indicate that one of the behavioral trends has been identified.

26. The computer program product according to claim 25, wherein each of the at least two performance metrics comprises a time series.

27. The computer program product according to claim 25, wherein the at least two performance metrics comprise at least three performance metrics.

28. The computer program product according to claim 25, wherein the online ad entity is selected from the group consisting of: an individual ad, a set of ads, a campaign and a set of campaigns.

29. The computer program product according to claim 25, wherein the at least two performance metrics are selected from the group consisting of: impressions, clicks, click-through rate (CTR), conversions, return on investment (ROI), revenue per click, cost per impression, cost per click, revenue per impression, reach and frequency.

30. The computer program product according to claim 25, wherein the program code is further executable by the at least one hardware processor for transmitting a command to an advertising platform, to affect a monetary parameter pertaining to the online ad entity,
wherein the command is based on the identified one of the behavioral trends.
